(19) United States
(12) Patent Application Publication
(10) Pub. No.: US 2007/0107609 A1
(43) Pub. Date: May 17, 2007

(54) Juicer

(75) Inventors: Mario John Chaves Barker, Kowloon (HK); Siu Yim Yung, Hong Lok Yuen (HK)

Correspondence Address: CHRISTIE, PARKER & HALE, LLP, PO BOX 7068, PASADENA, CA, 91109-7068, US

(73) Assignee: THERESA INTERNATIONAL LIMITED, Shatin, New Territories (HK)

(21) Appl. No.: 10/564,648

(22) PCT Filed: Jul. 13, 2004
(86) PCT No.: PCT/AU04/00944

§ 371 Date: Jul. 7, 2006

(30) Foreign Application Priority Data
Jul. 23, 2003 (AU) 2003903799
Aug. 18, 2003 (AU) 2003904365
Nov. 10, 2003 (AU) 2003906166

(51) Int. Cl. A23N 1/00

(52) U.S. Cl. 99/509

(57) ABSTRACT

This invention concerns a juicer, that is a machine for extracting the juice from fruit and vegetables. Such machines are used domestically, and also commercially in restaurants, cafes and juice bars. The invention comprises an electric motor, a shredder mounted for rotation by the motor, a feed tube to deliver pieces to be juiced to the shredder for juicing, wherein the feed tube has an inner diameter of more than 75 mm, and three, or more, inwardly directed formations are arranged to constrict the interior of the feed tube. The inner diameter of the feed tube may be large enough for a typical apple to pass through it whole such as 85 mm or more. The inwardly directed formations serve to prevent the insertion of a hand or arm into or through the feed tube despite its large diameter.

### TECHNICAL FIELD

This invention concerns a juicer, that is a machine for extracting the juice from fruit and vegetables. Such machines are used domestically, and also commercially in restaurants, cafes and juice bars.

### BACKGROUND ART

Juicers receive fruit or vegetables, either whole or cut into a suitable size. Where the skin is unpalatable or undesired it must be removed first. Juicers operate in different ways to extract the juice, but one popular way is by grating or shredding the fruit, separating the resulting pith and juice, and then dispensing the juice.

Citrus juicers extract the juice from cut citrus fruit without removing the peel, and generally operate in a different manner to other juicers. In citrus style juicers the cut surface of the fruit is pressed onto a pyramidal hub and then squeezed and rotated relative to the hub to convert almost the entire contents of the fruit to liquid. The peel is then discarded.

### DISCLOSURE OF THE INVENTION

The invention is a juicer for fruit and vegetables, comprising:

an electric motor having a driven output shaft;

a shredder mounted for rotation about its axis to the output shaft of the motor;

a feed tube to deliver pieces to be juiced to the shredder for juicing;

where the feed tube has an inner diameter of more than 75 mm, and three, or more, inwardly directed formations are arranged to constrict the interior of the feed tube.

The inner diameter of the feed tube may be large enough for a typical apple to pass through it whole; it may be 85 mm or more. The inwardly directed formations serve to prevent the insertion of a hand or arm into or through the feed tube despite the fact that the diameter is large enough for a typical apple to pass through.

The inwardly directed formations may be arranged about a collar at the top of the feed tube. Alternatively, the formations may be integrated into the walls of the feed tube. The formations may comprise ribs running down the collar or down the length of the walls of the feed tube. In a particularly preferred embodiment the feed tube has nine equispaced inwardly directed ribs, each 0.5 mm high or more. In this way the clear inner diameter is reduced to 75 mm or a little less.

The free end of the ribs running down the length of the feed tube may be a sharp edge to provide a cutting blade that is able to cut the pieces delivered by the feed tube to the shredder. The height of these ribs may increase down the length of the feed tube. This arrangement helps to prevent the piece from bouncing near the shredder wall by jamming the piece within the feed tube.

The shredder may have toothed sidewalls with axial symmetry, and it may be frusto-conical in shape. It may be mounted with the narrow end of the frusto-conical shredder to the output shaft of the motor and oriented with the axis of the frusto-conical shredder offset from vertical. It may also be mounted on bearings arranged around its wide end. The teeth may be arranged on the inner surface of the shredder. A frusto-conical sieve may extend from the wide end of the frusto-conical shredder. The lower end of the feed tube may be positioned adjacent the toothed sidewall of the shredder.

A lid assembly may enclose the frusto-conical sieve. The sidewalls of the sieve may be offset to the sidewalls of the shredder. It may provide a spout extending downwardly from sieve to dispense juice into a beaker. It may also provide a pulp receiving chamber offset to one side of the sieve. Optionally, the configuration of the offset of the axis of the shredder and the offset between the sidewalls of the shredder and sieve together with the rotating action of the shredder throws the pulp and juice up out of the shredder into the chamber and spout respectively.

A further invention provides fans blades around the top edge of the sieve to clear pulp from accumulating there and to move it into the pulp receiving chamber.

### BRIEF DESCRIPTION OF THE DRAWINGS

An example of this invention will now be described with reference to the accompanying drawings, in which:

FIG. 1 is a sectional view through a juicer;

FIG. 2 is a plan view into the feed tube;

FIG. 3 is a pictorial view of the feed tube and pusher;

FIG. 4 is a plan view of an alternate feed tube;

FIG. 5 is a sectional view of the feed tube of FIG. 4;

FIG. 6 is a detailed sectional view of the juicer of FIG. 1 in use;

FIG. 7 is pictorial view of a conical sieve fitted with fan blades; and,

FIG. 8 is a partial section view of a shredder, sieve and pulp collecting chamber.

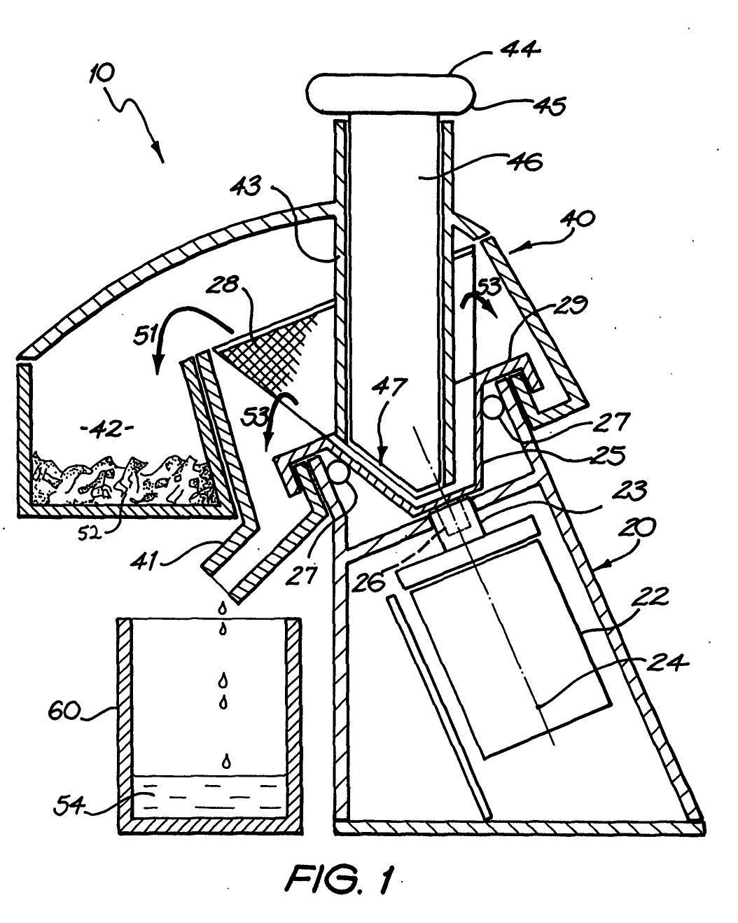

### BEST MODE OF THE INVENTION

The juicer 10 is designed to sit on a counter top and comprises a main unit 20, a lid assembly 40 and a juice receiving beaker 60.

An electric motor 22 is mounted inside the main unit 20, and has its output shaft 23 lying on axis 24 offset from the vertical. The output shaft is connected to a shredder 25. Shredder 25 is generally frusto-conical in shape and is also aligned with axis 24. It is oriented downwards and mounted at its narrow end 26 to the output shaft 23. It is also mounted on bearings 27 supported by the housing of the main unit 20. A generally frusto-conical sieve 28 extends above the upper part of the shredder. A lateral extension 29 of the upper part of the shredder 25 extends to cover over the bearings 27 and the join with the lid assembly 40.

The lid assembly 40 encloses the frusto-conical sieve 28. It provides a spout 41 extending downwardly from sieve 28 to dispense juice into beaker 60. It also provides a pulp receiving chamber 42 offset to one side of the sieve 28, and a fruit or vegetable receiving feed tube 43 which extends vertically down through the lid into the sieve 25. A ‘pusher’ 44 is provided with a handle 45 and a closed tubular body sized to sit inside tube 43.

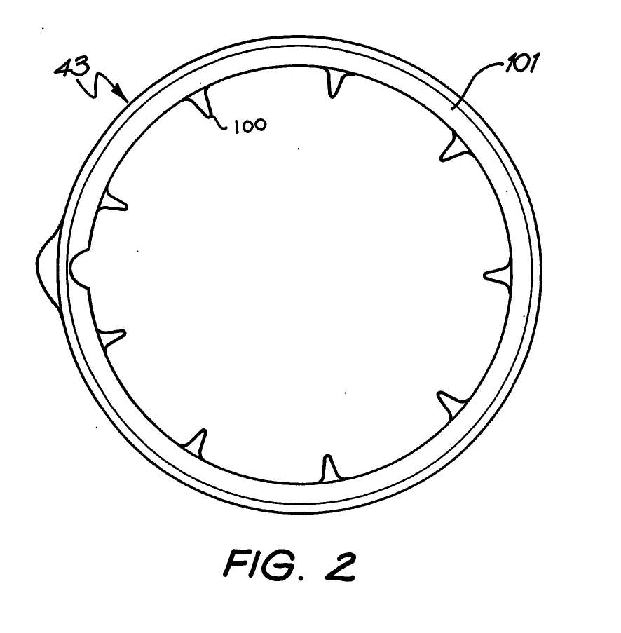

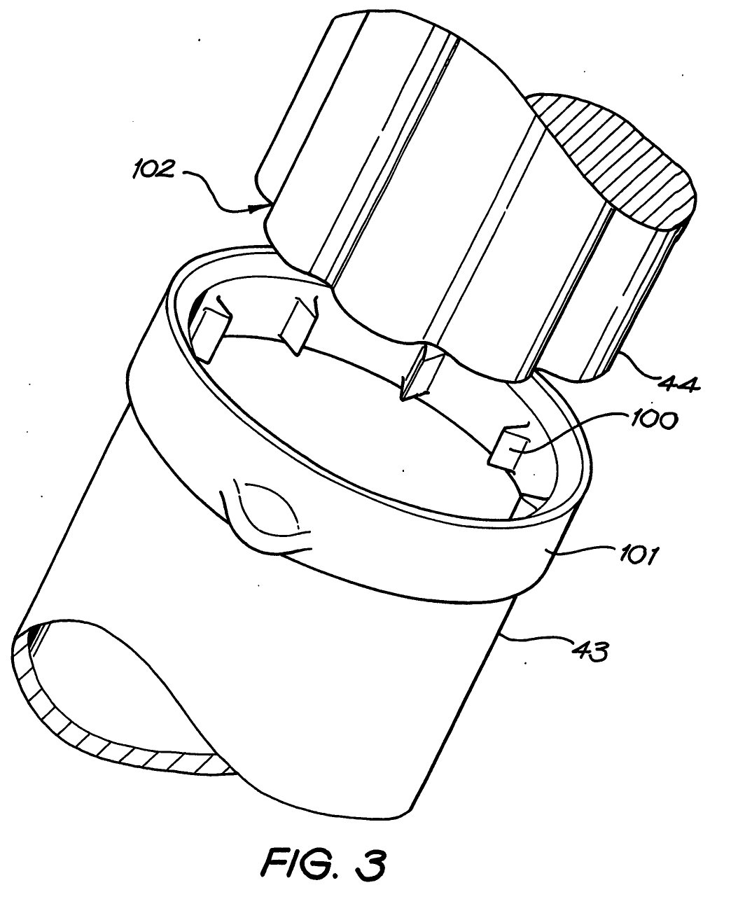

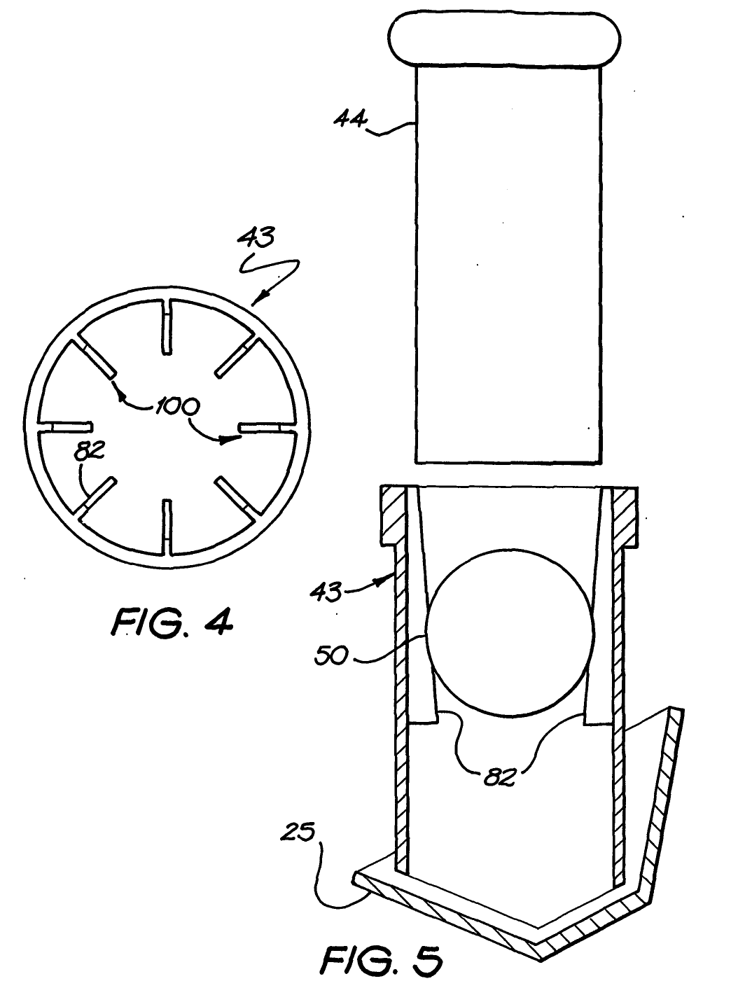

Referring now to FIGS. 2 and 3, the fruit or vegetable receiving tube 43, or feed tube, is seen to have an inner diameter of 85 mm. 85 mm is large enough for many apples to be inserted down the feed tube whole. Nine ribs, one of which is marked 100, are each 5.5 mm high and are equispaced around the inner face of a collar 101 mounted at the upper end of the feed tube. The nine ribs 100 reduce the clear inside diameter of the feed tube to 74 mm. This improves safety by restricting the feed tube to the extent that it is difficult for user to insert a hand down it. The body of the pusher 44 is shaped 102 to accommodate the ribs, as shown in FIG. 3, so that it can enter the feed tube 43 and push the fruit or vegetables down to the lower end. The space between the nine ribs is 24.5 mm. In a further example shown in FIG. 4, the ribs 100 of the feed tube 43 may extend down a portion of the length of the feed tube 43 and also increase in height as shown in FIG. 5. The free ends 82 of the ribs 100 may be sharp and thin so as to form blades 80. In this way, as the fruit or vegetable is pushed down the feed tube 43, it becomes trapped and reduces the amount that it bounces at the sidewall of the shredder.

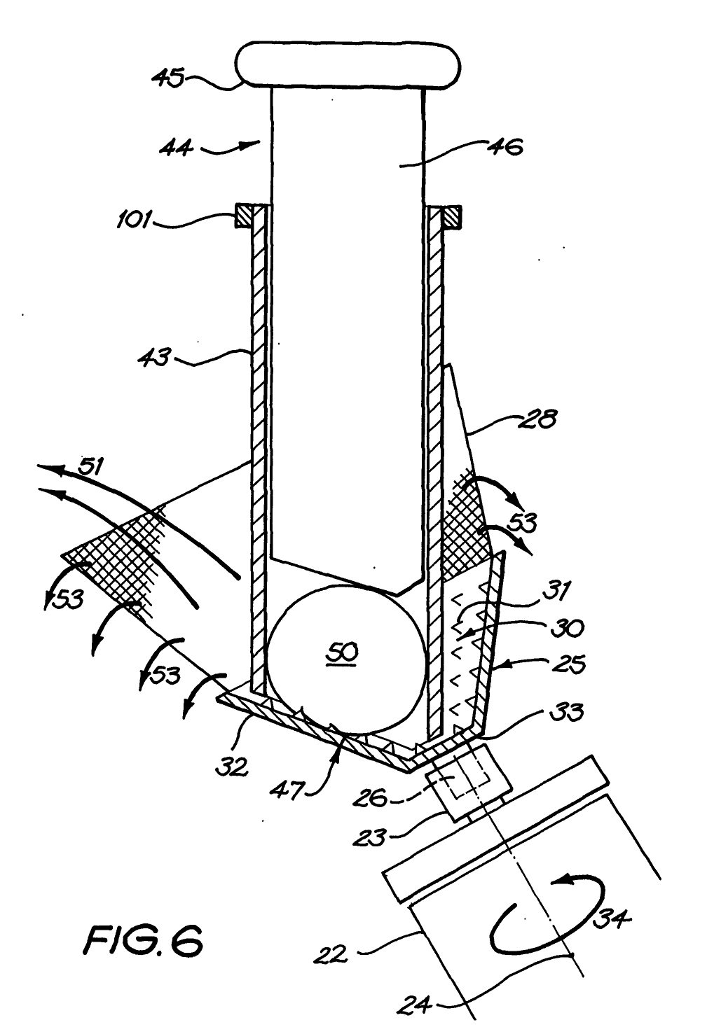

Referring in addition to FIG. 6 the juicer will be now be described in greater detail together with its operation and use. The inner surface 30 of shredder 25 is covered with teeth 31 around its sidewalls 32 and on surface 33 of the narrow end of the shredder 25. Teeth 31 are oriented to tear when the shredder 25 is spun about axis 24 in the direction indicated by arrow 34. The lower end 47 of feed tube 43 enters the shredder 25 and opens all along the sidewall 32 and partly along the surface 33 at the narrow end of the shredder 25. When the motor 22 is energised its output shaft 23 spins, causing the entire shredder 25 to spin about axis 24 in the direction indicated by arrow 34.

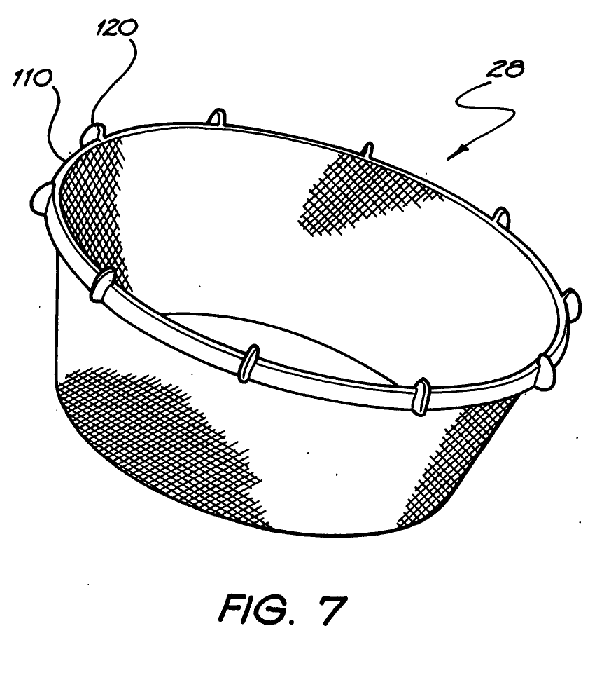

Referring now to FIG. 7 sieve 28 is seen to have an upper rim 110 of plastics material bearing 10 integrally moulded fan blades, one of which is indicated at 120.

In use, fruit or vegetables are whole or cut into pieces small enough to enter tube 43. Because the inner diameter of the feed tube 43 is 85 mm a whole apple 50 can pass through it and used to describe this example. The apple 50 is pushed into the top of the feed tube 43, passing through the collar 101 and being scored by ribs 100 if large enough to engage them. The apple 50 can then fall freely through the remainder of the feed tube 43. Pusher 44 can be used to help the apple past the ribs 100 if necessary. The motor 22 is connected to the mains electricity supply by means of a conventional lead and plug, and the motor 22 is energised. The apple 50 is pushed down feed tube 43 by pusher 46 and exit at the lower open end 47. Here the apple 50 is shown to meet the rotating teeth 31, and are torn up, converting them to pulp and juice.

The rotating action of the shredder 25 and the offset angle of axis 24 throws the pulp and juice up out of the shredder in a predicable direction. The sieve wall is offset at a small angle, say 8°, to the shredder wall. This has the effect of slowing down the exit of pulp and juice out of the shredder. The pulp is thrown up in direction 51 out of the shredder 25 and sieve 28. Chamber 42 is located to receive and collect the pulp 52, and the lid 40 is shaped to guide the pulp into the chamber 42. At the same time the juice is thrown up the sides of sieve 28 where it passes through in the direction indicated by arrows 53. Any pulp entrained in the juice is collected on the surface of sieve 28 where it falls back into the shredder and is again thrown out. The juice 54 is drained away by spout 41 and collected in beaker 60.

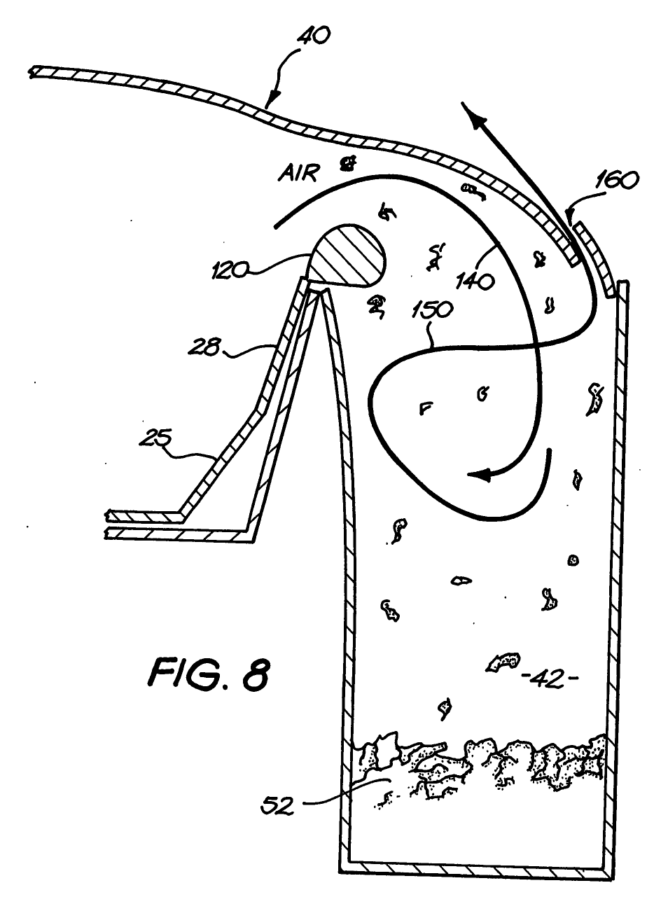

Referring further to FIG. 8 the fan blades 120 around the upper rim 110 of sieve 28 stir up strong air currents 140 to carry pulp into the pulp receiving chamber 42 and prevent it from accumulating and blocking the passage from the sieve 28 to the pulp receiving chamber 42. An air vent 160 above the pulp receiving chamber 42 allows the spent air 150 to escape.

The multiple bearings 26 and 27 serve to stabilize the shredder against the force exerted down on it by the pusher, and this in turn protects the bearings of the motor 22, the overall effect is to provide longevity to the moving parts. The offset axis 24 allows the pieces to be introduced vertically and be delivered to the sidewall 32 of the shredder 25. Tearing of the apple 50 occurs by the transverse movement of the teeth 31 across substantially the entire open end of the feed tube 43, causing efficient shredding. The lateral movement of the teeth 31 also tends to entrain the apple 50 and prevents it from spinning.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A juicer for fruit and vegetables, comprising:
an electric motor having a driven output shaft;
a shredder mounted for rotation about its axis to the output shaft of the motor;
a feed tube to deliver pieces to be juiced to the shredder for juicing;
where the feed tube has an inner diameter of more than 75 mm, and three, or more, inwardly directed formations are arranged to constrict the interior of the feed tube.

2. A juicer for fruit and vegetables according to claim 1, wherein the inner diameter of the feed tube is 85 mm or more.

3. A juicer for fruit and vegetables according to claim 1 or 2, wherein the inwardly directed formations are arranged about a collar at the top of the feed tube.

4. A juicer for fruit and vegetables according to claim 1 or 2, wherein the inwardly directed formations comprise ribs running down the collar.

5. A juicer for fruit and vegetables according to claim 1 or 2, wherein the inwardly directed formations are integrated into the walls of the feed tube.

6. A juicer for fruit and vegetables according to claim 1, or 2 wherein the inwardly directed formations comprise ribs running down the length of the walls of the feed tube.

7. A juicer for fruit and vegetables according to claim 6, wherein the free edge of the ribs down the length of the feed tube is sharp to provide a cutting blade.

8. A juicer for fruit and vegetables according to claim 7, wherein the ribs increase in height running down the length of the feed tube.

9. A juicer for fruit and vegetables according claim 1, wherein the formations are nine equispaced inwardly directed ribs.

10. A juicer for fruit and vegetables according to claim 1, wherein each formation is 5.5 mm high or more.

11. A juicer for fruit and vegetables according to claim 1, wherein the shredder has toothed sidewalls with axial symmetry, and is frusto-conical in shape.

12. A juicer for fruit and vegetables according to claim 11, wherein the shredder is mounted with the narrow end of the frusto-conical shredder to the driven output shaft of the motor and oriented with the axis of the frusto-conical shredder offset from vertical.

13. A juicer for fruit and vegetables according to claim 11, wherein the shredder is mounted on bearings arranged around the wide end of the frusto-conical shredder.

14. A juicer for fruit and vegetables according claim 11, wherein a frusto-conical sieve extends from the wide end of the frusto-conical shredder.

15. A juicer for fruit and vegetables according to claim 11, wherein the lower end of the feed tube is positioned adjacent the toothed sidewall of the shredder.

16. A juicer for fruit and vegetables according to claim 14, wherein the sidewalls of the sieve are offset to the sidewalls of the shredder.

17. A juicer for fruit and vegetables according to claim 14, wherein a lid assembly encloses the frusto-conical sieve, where the lid assembly provides a spout extending downwardly from sieve to dispense juice into a beaker and a pulp receiving chamber offset to one side of the sieve.

18. A juicer for fruit and vegetables according to claim 17, wherein the configuration of the offset of the axis of the shredder and the offset between the sidewalls of the shredder and sieve together with the rotating action of the shredder throws the pulp and juice up out of the shredder into the chamber and spout respectively.

19. A juicer for fruit and vegetables according to claim 17, wherein fans blades are provided around the top edge of the sieve to clear pulp from accumulating there and to move it into the pulp receiving chamber.
